(19) United States
(12) Patent Application Publication
(10) Pub. No.: US 2022/0318586 A1
(43) Pub. Date: Oct. 6, 2022

(54) DYNAMIC MONITORING SYSTEM WITH RADIO-FREQUENCY IDENTIFICATION

(71) Applicant: Smart Automation Technology Inc., New Taipei (TW)

(72) Inventors: Tsai-Chih LIN, NEW TAIPEI (TW); Wen-Tzong LEE, NEW TAIPEI (TW); Che-Fu LIU, NEW TAIPEI (TW); Ruei-Yang CHEN, NEW TAIPEI (TW)

(21) Appl. No.: 17/219,177

(22) Filed: Mar. 31, 2021

(51) Int. Cl. G06K 19/077; G06K 19/07; H04N 5/33

(52) U.S. Cl. CPC G06K 19/07713; G06K 19/0717; G06K 19/07762; G06K 19/07703; G06K 19/0723; H04N 5/33

(57) ABSTRACT

A dynamic monitoring system with radio-frequency identification includes a radio-frequency identification (RFID) tag, at least two radio-frequency identification (RFID) detectors and a processing device. The RFID tag is installed on a moving user. When the user enters a preset detection range, at least two RFID detectors detect the RFID tag and generate an identification signal, respectively. The processing device is coupled to at least two RFID detectors. The processing device generates a distance signal between the RFID tag and the at least two RFID detectors according to the identification signals and positions of the at least two RFID detectors. The processing device generates a positioning signal relevant to a position of the RFID tag within the preset detection range according to the distance signal.

### FIELD OF THE INVENTION

The present invention relates to a monitoring system, and particularly to a dynamic monitoring system with radio-frequency identification.

### BACKGROUND OF THE INVENTION

Dynamic monitoring of personnel has always been an essential issue in today's society. In companies or factories, it is often necessary to control and monitor personnel's entry and exit. In stations, department stores or gatherings, control and monitor of personnel are also crucial tasks.

At present, most monitoring and management systems utilize human power to identify or measure body temperature, and specific personnel are required to identify or measure body temperature of passing personnel, or passing personnel may operate a clock in a device to clock in by themselves. The existing monitoring system is not only cumbersome and slow, but also requires additional manpower. When personnel are queuing up to clock in, they also increase the risk of contact, which may cause the spread of diseases. Therefore, how to improve the efficiency and accuracy of the monitoring system is a matter of urgency, and how to establish an effective monitoring system is the focus of attention of relevant personnel in the field.

### SUMMARY OF THE INVENTION

The present invention provides a dynamic monitoring system with radio-frequency identification capable of substantially improving the efficiency and accuracy of dynamic monitoring of personnel.

Other objects and advantages of the present invention can be further understood from the technical features disclosed in the present invention.

A dynamic monitoring system with radio-frequency identification of the present invention comprises a radio-frequency identification (RFID) tag, at least two radio-frequency identification (RFID) detectors and a processing device. The RFID tag is installed on a user who is moving. When the user enters a preset detection range, at least two RFID detectors detect the RFID tag and generate an identification signal, respectively. The processing device is coupled to at least two RFID detectors. The processing device generates a distance signal between the RFID tag and the at least two RFID detectors according to the identification signals and positions of the at least two RFID detectors. The processing device generates a positioning signal relevant to a position of the RFID tag within the preset detection range according to the distance signal.

In one embodiment of the present invention, a quantity of the RFID detector is two, the two RFID detectors are respectively located at a first coordinate and a second coordinate, and the processing device generates the positioning signal according to the first coordinate, the second coordinate and the identification signals.

In one embodiment of the present invention, the identification signal comprises distance information between the RFID tag and the at least two RFID detectors.

In one embodiment of the present invention, the processing device obtains the distance information according to frequency, wavelength and/or time of a detection signal communicated between at least two RFID detectors and the RFID tag.

In one embodiment of the present invention, the dynamic monitoring system with radio-frequency identification further comprises a thermal visualization device, the thermal visualization device is used for sensing a body temperature of the user to generate body temperature data, and the user has the RFID tag.

In one embodiment of the present invention, the dynamic monitoring system with radio-frequency identification further comprises a thermal visualization device and an image processing device. The thermal visualization device is used to sense at least one user to generate a thermal image, each of at least one user has the RFID tag, the image processing device analyzes the thermal image to generate an image processing data. The processing device generates the positioning signal according to the image processing data, the identification signals, and positions of the at least two RFID detectors.

In one embodiment of the present invention, the image processing device comprises a position analyzer, the position analyzer analyzes relative relationships between images of at least one user in the thermal image to generate the image processing data.

In one embodiment of the present invention, the processing device further comprises a personnel data and/or an attendance data, the processing device generates a dynamic personnel data according to the personnel data, the identification signal and the positioning signal, or the processing device generates the dynamic personnel data according to the attendance data, the identification signal and the positioning signal, or the processing device generates the dynamic personnel data according to the personnel data, the attendance data, the identification signal and the positioning signal.

In one embodiment of the present invention, the processing device further comprises personnel data and/or attendance data. The processing device generates a dynamic personnel data according to the personnel data, the identification signal, the positioning signal and the body temperature data.

Based on the above, the dynamic monitoring system with radio-frequency identification provided by the present invention is capable of accurately and effectively identifying and positioning the RFID tag through the at least two RFID detectors, and therefore capable of substantially improving the efficiency and accuracy of dynamic monitoring of personnel.

In order to make the above-mentioned features and advantages of the present invention more obvious and comprehensible, the following specific embodiments are described in detail in conjunction with the accompanying drawings.

### BRIEF DESCRIPTION OF THE DRAWINGS

FIG. 1 is a schematic diagram of a dynamic monitoring system with radio-frequency identification according to an embodiment of the present invention;

FIG. 2 is a schematic diagram of the dynamic monitoring system with radio-frequency identification according to an embodiment of the present invention;

FIG. 3 is a functional block diagram of the dynamic monitoring system with radio-frequency identification according to an embodiment of the present invention;

FIG. 4 is a schematic diagram of detection signals communicated between RFID detectors and a RFID tag according to an embodiment of the present invention; and

FIG. 5 is a schematic diagram of a thermal image of the dynamic monitoring system with radio-frequency identification according to an embodiment of the present invention.

### DETAILED DESCRIPTION OF THE PREFERRED EMBODIMENTS

The aforementioned and other technical content, features and efficacies of the present invention will be clearly presented in the following detailed description of a preferred embodiment with reference to the drawings. The directional terms mentioned in the following embodiment, for example: up, down, above, below, left, right, front or back, etc., are merely directions for referring to the attached drawings. Therefore, the directional terms are used to illustrate but are not intended to limit the present invention.

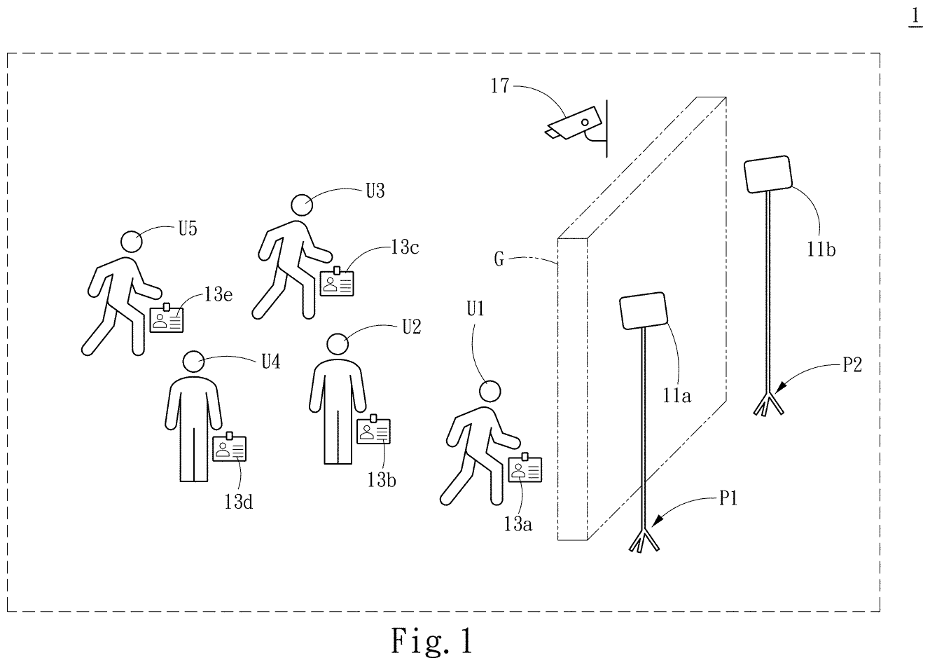

Please refer to FIG. 1 for a schematic diagram of a dynamic monitoring system with radio-frequency identification according to an embodiment of the present invention. A dynamic monitoring system with radio-frequency identification 1 is capable of accurately and effectively identifying and positioning radio-frequency identification (RFID) tags 13a, 13b, 13c, 13d, 13e, and capable of substantially improving the efficiency and accuracy of dynamic monitoring of personnel (such as users U1, U2, U3, U4, U5 shown in FIG. 1). Specific operation details will be explained in detail below.

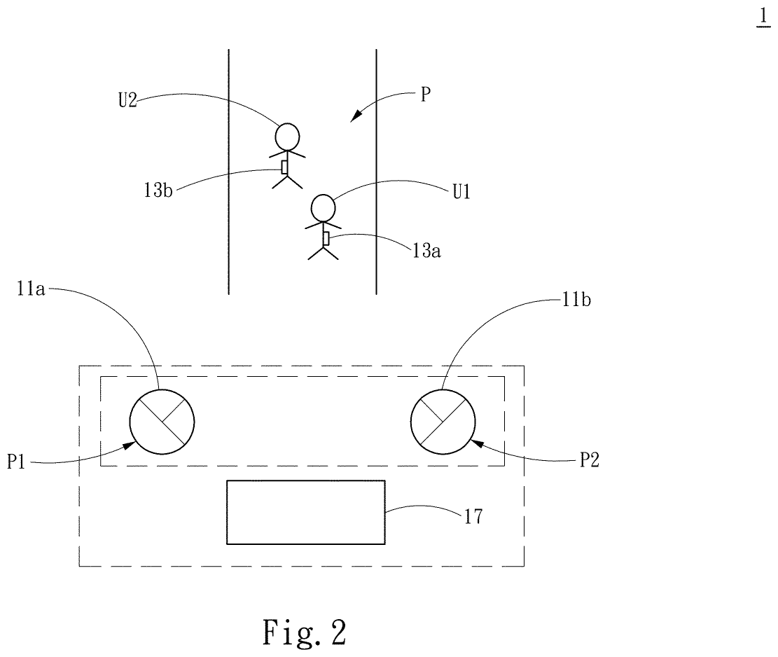

Please refer to FIG. 2 for a schematic diagram of the dynamic monitoring system with radio-frequency identification 1 of the embodiment shown in FIG. 1 to clearly show disposal of at least two radio-frequency identification (RFID) detectors 11a, 11b. In this embodiment, the RFID tags 13a, 13b are taken as examples.

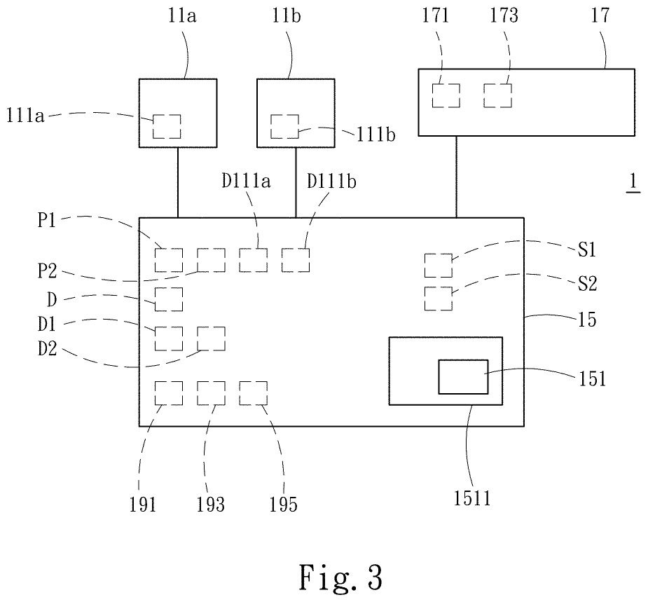

Please refer to FIG. 3, a functional block diagram of the dynamic monitoring system with radio-frequency identification 1 of the embodiments shown in FIG. 1 and FIG. 2. The dynamic monitoring system with radio-frequency identification 1 includes the RFID tags 13a, 13b, the at least two RFID detectors 11a, 11b, and a processing device 15. As shown in FIG. 1 and FIG. 2, one of the RFID tags 13a is installed on one of the users U1 who is moving, and the other one of the RFID tags 13b is installed on the other one of the users U2 who is moving. FIG. 1 shows a gateway G as a schematic illustration.

For example, when one of the users U1 enters a preset detection range P (as shown in FIG. 2), the at least two RFID detectors 11a, 11b detect one of the RFID tags 13a disposed on one of the users U1 and generate identification signals 111a, 111b, respectively. The processing device 15 is coupled to the two RFID detectors 11a, 11b. The processing device 15 generates a distance signal D between one of the RFID tags 13a and the at least two RFID detectors 11a, 11b according to the identification signals 111a, 111b and positions (i.e. a first coordinate P1 and a second coordinate P2) of the at least two RFID detectors 11a, 11b. The processing device 15 generates a positioning signal S1 relevant to a position of one of the RFID tags 13a within the preset detection range P according to the distance signal D. That is, the identification signals 111a, 111b are capable of identifying one of the RFID tags 13a, and the positioning signal S1 is capable of displaying a position of one of the RFID tags 13a. Thereby, through the disposal of the at least two RFID detectors 11a, 11b, the dynamic monitoring system with radio-frequency identification 1 is capable of accurately and effectively identifying and positioning one of the RFID tags 13a, and capable of substantially improving the efficiency and accuracy of dynamic monitoring of personnel (i.e., one of the users U1). Similarly, when the other one of the users U2 enters the preset detection range P, the at least two RFID detectors 11a, 11b detect the other one of the RFID tags 13b installed on the other one of the users U2 and respectively generate the identification signals 111a, 111b. The processing device 15 is capable of accurately and effectively identifying and positioning the other one of the RFID tags 13b according to the identification signals 111a, 111b and positions of the at least two RFID detectors 11a, 11b.

Specifically, by setting positions of at least two RFID detectors 11a, 11b, the preset detection range P can be defined according to the requirement. In this embodiment, the dynamic monitoring system with radio-frequency identification 1 including the two RFID detectors 11a, 11b is used as an example, but the present invention does not limit a quantity of the RFID detectors. A greater quantity of the RFID detectors may improve positioning accuracy and performance of the dynamic monitoring system with radio-frequency identification 1. In this embodiment, the dynamic monitoring system with radio-frequency identification 1 including the two RFID tags 13a, 13b is used as an example, but the present invention does not limit a quantity of the RFID tags. The processing device 15 can be implemented by, such as a processor, an electronic component, and/or a circuit, and the present invention is not limited thereto.

In one embodiment of the present invention, a quantity of the at least two RFID detectors 11a, 11b of the dynamic monitoring system with radio-frequency identification 1 is only two. As shown in FIG. 2, one embodiment of the present invention, the two RFID detectors 11a, 11b are respectively located at the first coordinate P1 and the second coordinate P2. The processing device 15 generates the positioning signal S1 according to the first coordinate P1, the second coordinate P2, and the identification signals 111a, 111b.

In one embodiment of the present invention, one of the identification signals 111a of the dynamic monitoring system with radio-frequency identification 1 includes a distance information D1 between one of the RFID tags 13a and one of the two RFID detectors 11a, and one of the identification signals 111b includes a distance information D2 between the other one of the RFID tags 13b and the other one of the RFID detectors 11b. That is, the identification signals 111a, 111b includes two distance information D1, D2 between one of the RFID tags 13a and the two RFID detectors 11a, 11b, respectively. Thereby, the processing device 15 is capable of generating the positioning signal S1 according to the two distance information D1, D2 and the identification signals 111a, 111b. Similarly, one of the identification signals 111b includes the two distance information D1, D2 between the other one of the RFID tags 13b and the two RFID detectors 11a, 11b, respectively. Thereby, the processing device 15 is capable of accurately and effectively identifying and positioning two of the RFID tags 13a, 13b.

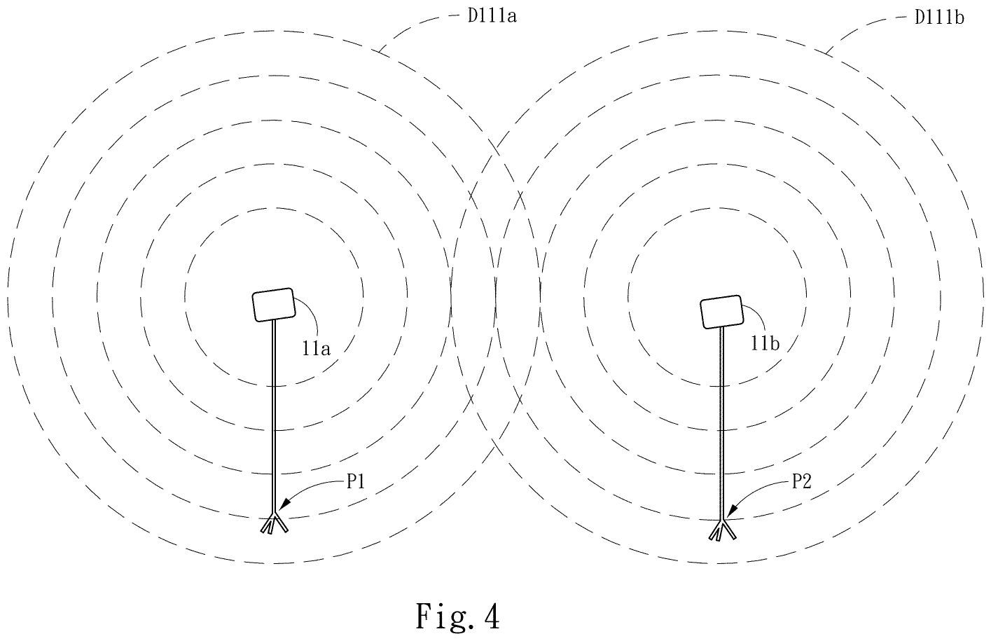

Please refer to FIG. 4, which is a schematic diagram of a detection signal D111a communicated between the RFID detector 11a and a RFID tag, and a detection signal D111b communicated between the RFID detector 11b and the RFID tag according to an embodiment of the present invention. In this embodiment, one of the RFID tags 13a is taken as an example. The processing device 15 of the dynamic monitoring system with radio-frequency identification 1 obtains the distance information D1 according to frequency, wavelength and/or time of a detection signal D111a communicated between one of the RFID detectors 11a and one of the RFID tags 13a. The processing device 15 obtains the distance information D2 according to frequency, wavelength and/or time of a detection signal D111b communicated between the other one of the RFID detectors 11b and the other one of the RFID tags 13b. Two detection signals D111a, D111b are RFID detection signals generated by the two RFID detectors 11a, 11b, respectively. Thereby, the dynamic monitoring system with radio-frequency identification 1 is capable of obtaining the two distance information D1, D2 of the two RFID detectors 11a, 11b relative to two of the RFID tags 13a, 13b respectively through frequencies, wavelengths and/or time of the two detection signals D111a, D111b, and capable of accurately and effectively identifying and positioning two of the RFID tags 13a, 13b.

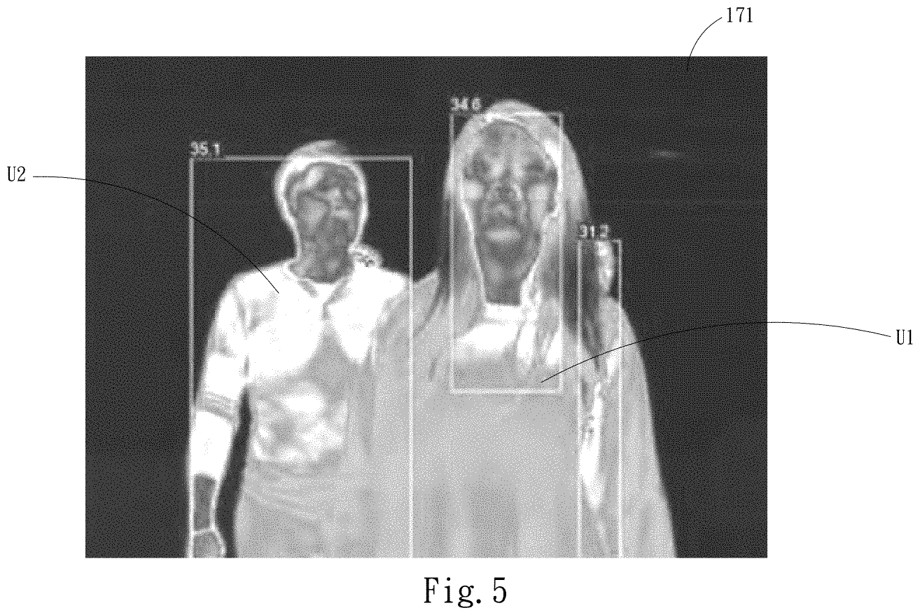

Please refer to FIG. 5, a schematic diagram of a thermal image 171 of the dynamic monitoring system with radio-frequency identification 1 according to an embodiment of the present invention. The dynamic monitoring system with radio-frequency identification 1 can further include a thermal visualization device 17 (as shown in FIG. 1) which is coupled to the processing device 15 and used to sense the body temperature of one of the users U1 to generate a body temperature data 173. One of the users U1 includes one of the RFID tags 13a. Thereby, the dynamic monitoring system with radio-frequency identification 1 is capable of obtaining the body temperature data 173 of one of the users U1 with one of the RFID tags 13a, which can be applied to body temperature monitoring of personnel, for example.

Similarly, the thermal visualization device 17 is capable of sensing the body temperature of the other one of the users U2 to generate corresponding body temperature data. The thermal visualization device 17 can be implemented by any possible thermal sensing and/or image capturing device, and the present invention is not limited thereto.

In one embodiment of the present invention, the dynamic monitoring system with radio-frequency identification 1 can further include an image processing device 151. The thermal visualization device 17 is used to sense the users U1, U2 to generate the thermal image 171. The users U1, U2 respectively, include the RFID tags 13a, 13b. The image processing device 151 analyzes the thermal image 171 to generate image processing data S2. The processing device 15 generates the positioning signal S1 of one of the RFID tag 13a according to the image processing data S2, the identification signals 111a, 111b, and positions (i.e., the first coordinate P1, the second coordinate P2) of the RFID detectors 11a, 11b. By analyzing the thermal image 171, the dynamic monitoring system with radio-frequency identification 1 is capable of substantially improving the efficiency and accuracy of dynamic monitoring of personnel. Method of generating the positioning signal S1 of the other one of the RFID tags 13b is similar to one of the RFID tags 13a, and thus will not be repeated here. In this embodiment, the image processing device 151 being disposed in the processing device 15 is used as an example, but the present invention is not limited thereto. The image processing device 151 can be implemented by any possible software, firmware, electronic components, and/or circuits.

In one embodiment of the present invention, the image processing device 151 of the dynamic monitoring system with radio-frequency identification 1 can further include a position analyzer 1511, for example. The position analyzer 1511 analyzes relative relationships between images of the users U1, U2 in the thermal image 171 to generate the image processing data S2. For example, the position analyzer 1511 is capable of generating the image processing data S2 by determining front and back positions of the users U1, U2 according to sizes of images of the users U1, U2 in the thermal image 171. For example, the position analyzer 1511 is capable of generating the image processing data S2 by determining relationships between left and right positions of the users U1, U2 according to left and right relationships of images of the users U1, U2 in the thermal image 171. Through disposal of the position analyzer 1511, the dynamic monitoring system with radio-frequency identification 1 is capable of substantially improving the efficiency and accuracy of dynamic monitoring of personnel.

In one embodiment of the present invention, the processing device 15 of the dynamic monitoring system with radio-frequency identification 1 further includes a personnel data 191 and/or an attendance data 193. The processing device 15 generates a dynamic personnel data 195 according to the personnel data 191, the identification signals 111a, 111b, and the positioning signal S1. Thereby, the dynamic monitoring system with radio-frequency identification 1 can be applied to, for example, personnel attendance management.

In one embodiment of the present invention, the processing device 15 generates the dynamic personnel data 195 according to the attendance data 193, the identification signals 111a, 111b, and the positioning signal S1. Thereby, the dynamic monitoring system with radio-frequency identification 1 can be applied to, for example, personnel attendance management.

In one embodiment of the present invention, the processing device 15 generates the dynamic personnel data 195 according to the personnel data 191, the attendance data 193, the identification signals 111a, 111b, and the positioning signal S1. Thereby, the dynamic monitoring system with radio-frequency identification 1 can be applied to personnel attendance management, for example.

In one embodiment of the present invention, the processing device 15 of the dynamic monitoring system with radio-frequency identification 1 further includes the personnel data 191 and/or the attendance data 193. The processing device 15 generates the dynamic personnel data 195 according to the personnel data 191, the identification signals 111a, 111b, the positioning signal S1, and the body temperature data 173. Thereby, the dynamic monitoring system with radio-frequency identification 1 can be applied to, for example, body temperature monitoring and attendance management of personnel.

In summary, the dynamic monitoring system with radio-frequency identification of the embodiments of the present invention is capable of accurately and effectively identifying and positioning the RFID tags through the at least two RFID detectors, and capable of substantially improving the efficiency and accuracy of dynamic monitoring of personnel.

What is claimed is:

1. A dynamic monitoring system with radio-frequency identification, comprising:
a radio-frequency identification (RFID) tag, installed on a user who is moving;
at least two radio-frequency identification (RFID) detectors, when the user entering a preset detection range, the at least two RFID detectors detecting the RFID tag and generating an identification signal respectively; and
a processing device, coupled to at least two RFID detectors, the processing device generates a distance signal between the RFID tag and the at least two RFID detectors according to the identification signals and positions of the at least two RFID detectors, and the processing device generates a positioning signal relevant to a position of the RFID tag within the preset detection range according to the distance signal.

2. The dynamic monitoring system with radio-frequency identification as claimed in claim 1, wherein a quantity of the RFID detectors is two, the two RFID detectors are respectively located at a first coordinate and a second coordinate, and the processing device generates the positioning signal according to the first coordinate, the second coordinate and the identification signals.

3. The dynamic monitoring system with radio-frequency identification as claimed in claim 1, wherein the identification signal comprises distance information between the RFID tag and the at least two RFID detectors.

4. The dynamic monitoring system with radio-frequency identification as claimed in claim 3, wherein the processing device obtains the distance information according to frequency, wavelength and/or time of a detection signal communicated between at least two RFID detectors and the RFID tag.

5. The dynamic monitoring system with radio-frequency identification as claimed in claim 1, further comprising a thermal visualization device, the thermal visualization device being used for sensing a body temperature of the user to generate body temperature data, and the user having the RFID tag.

6. The dynamic monitoring system with radio-frequency identification as claimed in claim 1, further comprising a thermal visualization device and an image processing device, the thermal visualization device being used to sense at least one user to generate a thermal image, each of the at least one user having the RFID tag, the image processing device analyzing the thermal image to generate an image processing data, and the processing device generating the positioning signal according to the image processing data, the identification signals, and positions of the at least two RFID detectors.

7. The dynamic monitoring system with radio-frequency identification as claimed in claim 6, wherein the image processing device comprises a position analyzer, the position analyzer analyzes relative relationships between images of the at least one user in the thermal image to generate the image processing data.

8. The dynamic monitoring system with radio-frequency identification as claimed in claim 5, wherein the processing device further comprises a personnel data and/or an attendance data, the processing device generates a dynamic personnel data according to the personnel data, the identification signal and the positioning signal, or the processing device generates the dynamic personnel data according to the attendance data, the identification signal and the positioning signal, or the processing device generates the dynamic personnel data according to the personnel data, the attendance data, the identification signal and the positioning signal.

9. The dynamic monitoring system with radio-frequency identification as claimed in claim 5, wherein the processing device further comprises a personnel data and/or an attendance data, and the processing device generates a dynamic personnel data according to the personnel data, the identification signal, the positioning signal and the body temperature data.
